(19) United States
(12) Patent Application Publication
(10) Pub. No.: US 2012/0149654 A1
(43) Pub. Date: Jun. 14, 2012

(54) HUMIC SUBSTANCES AND USES THEREOF IN AGRO-ENVIRONMENT

(75) Inventors: Giuseppe Antonio Legname, Trieste (IT); Liviana Leita, Udine (UD) (IT); Paolo Sequi, Pietrasanta (LU) (IT)

(73) Assignee: SCUOLA INTERNAZIONALE SUPERIORE DI STUDI AVANZATI, Trieste (IT)

(21) Appl. No.: 13/384,116

(22) PCT Filed: Jul. 13, 2010
(86) PCT No.: PCT/IB2010/053203

§ 371 Date: Mar. 2, 2012

Related U.S. Application Data
(60) Provisional application No. 61/226,016, filed on Jul. 16, 2009.

(51) Int. Cl. A01N 43/04; A01P 1/00; A01N 37/10

(52) U.S. Cl. 514/23; 514/569

(57) ABSTRACT

The present invention relates to the two main categories of humic substances, humic acids and fulvic acids and their use for hindering the propagation and/or contamination with prion infectivity both in agricultural and environmental systems.

### FIELD OF INVENTION

The present invention relates to the two main categories of humic substances, humic acids and fulvic acids and their use for hindering the propagation of prion infectivity both in agricultural and environmental systems.

### STATE OF THE ART

Humic substances (HSs) are an ubiquitous reservoir of carbon, representing the bulk of organic matter present in soil, peat, lignites, brown coals, sewage, natural waters and their sediments. Being the decay products of the whole biota in the environment, they are highly refractory. They are formed through aerobic and anaerobic decomposition of plant and animal detritus, as well as secondary microbial synthesis. Their chemical structure is mainly built up by heteroatomic functionalities including phenols and other alcohols, ketones/quinones, aldehydes, carboxylic-, amino-, amido-, carbonylic- and nitro-groups, sulfur containing entities such as mercaptans, sulfates, and sulfonates, and aliphatic moieties. However, the term ‘humic substances’ is used in a generic sense to distinguish the naturally occurring material from the products of chemical extractions named humin, humic acids (HAs,) and fulvic acids (FAs), which are defined “operationally” by their solubility in alkali or acid solutions. Humic acids are soluble in alkaline solution, fulvic acids are soluble in both alkaline and acidic solution, while humin represents the insoluble residue. It is possible to envisage a general molecular configuration of the chemical structure of HSs, HAs and FAs in particolar, so that we speak of hypothetical model of basic block-structures like those reported below (see also Stevenson, 1994).

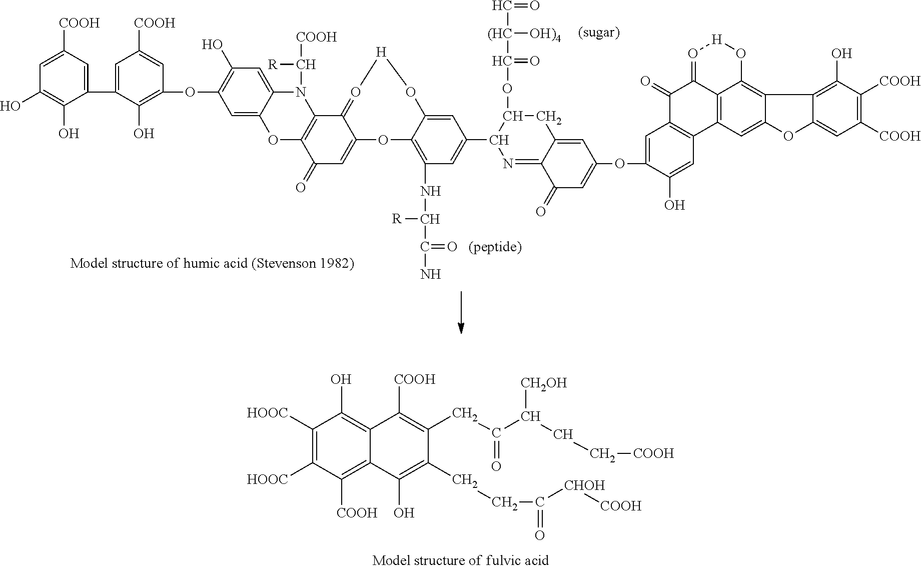

However, while these two classes of compounds share many structural features, FAs have lower molecular weight, higher functional group density, and higher acidity than HAs. Humic and fulvic acids are carbon-rich polydisperse polyanionic (at natural conditions) biopolymers, whose multiple properties seem to be purpose-built for many life-sustaining functions from agriculture (e.g. field fertilization apart, humates can also be used in animal husbandry for growth stimulation purposes) to industry (e.g. production of fertilizers), environment (chelation of organic substances and metals in soil and water systems) and biomedicine (e.g. cosmetics, antivirals, drugs for the stimulation of the immune system, detoxifying food suplements) (Pena-Mendez, 2005; Schiller et al., 1979; Riede et al., 1991; Schneider et al., 1996; Shermer et al., 1998).

One of the most significant properties of HAs and FAs or/and HA/FA-like substances is their ability to interact with xenobiotics forming complexes of different solubility and chemical and biochemical stability. Due to this poly-functionality, HAs and FAs therefore represent a strongly pH dependent reservoir of electron donors/acceptors, which could hypothetically contribute to reduction/oxidation of several inorganic and organic agents (Pacheco et al., 2003). They are able to complex heavy metals (Lubal et al., 1998; Kurk and Choppin, 2000; Borges et al., 2005; Campitelli et al., 2006), radio-nuclides (Lubal et al., 2000; Pacheco and Havel, 2001), inorganic anions (Leita et al., 2001; 2009), halogens (Lee et al., 2001; Myneni, 2002), organic acids (Cozzolino et al., 2001), aromatic compounds (Schulten et al., 2001; Nam and Kim, 2002), pesticides and herbicides (Chien and Bleam, 1997; De Paolis and Kukkonen, 1997; Schmitt et al., 1997; Fang et al., 1998; Ishiwata and Kamiya, 1999; Gevao et al., 2000; Klaus et al., 2000), viruses and proteins (Klocking et al., 1972; 1991; Schols et al., 1991; Loya et al., 1993) etc.

In addition, chemically HAs and FAs behave as supramolecules (Steed and Atwood, 2000) which are able to polymerize and aggregate (Fetsch et al., 1998), form micelles (Guetzloff and Rice, 1994) and might also form supramolecular ensembles with other compounds (Von Wandruszka, 2000; Pacheco et al 2003, Piccolo et al 2002, Arcon et al., 2006). The amphiphilic characteristic of HAs and FAs could therefore imply the possible interaction of these compounds with infectious proteins, such as prions, thus abating their infectivity. Prions are proteinaceous particles produced by the conversion of the cellular form of the prion protein (PrP^{C}) into a conformer (PrP^{Sc}) bearing different tertiary and quaternary protein folding. Prions are infectious pathogens causing transmission of the disease collectively known as the transmissible spongiform encephalopathies (TSE) thus causing fatal neurodegenerative disorders in different mammalian species, e.g. scrapie in sheep, bovine spongiform encephalopathy (BSE) in cattle, chronic wasting disease (CWD) in mule deer, elk, and moose (cervids), and Creutzfeldt-Jakob disease (CJD/vCJD) in humans. In contrast to the inability of scrapie prions to cross the ovine-man species barrier, BSE prions can be transmitted to humans through the consumption of infected beef products, giving rise to the novel human prion disease. As for CWD, the risk of transmission to humans is currently unknown, but the recent, extensive spread of the disease among free-ranging cervids in some areas of the U.S. raises concerns for public health.

Prions may enter the environment through many different pathways, including animal's excreta and secreta, application of fertilizers, leaching from infiltration of landfill waters, water run-off or even contamination of surface soils by either infected animal carcasses (with the accumulation of prion in nervous system and lymphoid tissues) or infected placenta remaining on the ground after whelping. Agricultural and industrial practices and the uncontrolled incineration of scrapie-contaminated tissues may contribute to prion's dissemination in the environment (Leita et al. 2006, Genovesi et al. 2007). Although there are established standard conditions for safe handling, transportation, and storage of infected meat and bone meal, accidental spillage during transportation or inappropriate storage may occur, as well as the spreading of effluents of slaughterhouses and rendering plants. One of the several astonishing properties of prions is their outstanding persistence into the environment, and their ability to remain infectious when prion-contaminated materials are interred in soil for several years. A notable feature of scrapie and CWD is horizontal transmission between grazing animals indicating contaminated soil as a good candidate for the vector of disease propagation. In this respect, it has been reported that grazing animals ingest from tens to hundreds grams of soil per day, either incidentally through the diet, or deliberately in answering salt needs, and that sheep and mule deer can develop CWD after grazing in locations that previously housed infected animals. However, effective potential hazard of soil associated TSE agents has only recently been proven by Seidel et al. (2007), who have indeed shown that not only the 263K scrapie agent can persist in soil for at least 29 months, but also that oral administration of contaminated soil or aqueous soil extracts was able to induce the disease to Syrian hamsters. An emerging issue is the possible use of mammalian meat and bone meal (mMBM) refuse as fertilizers. As the mad cow epidemic seems to have subsided, recent changes in EU legislation allow the use of these by-products for spreading on nonpasture agricultural land. However, in case of repeated fertilization with infectious materials, a risk of soil contamination could be reasonably assumed.

The neutralization of prion infectivity in agricultural and environmental matrices is therefore a priority in order to abate the propagation of TSE diseases. However the remarkable resistance of prions to inactivation could represent a serious problem since ordinary decontamination procedures do not effectively diminish prion infectivity. In fact, prions remain infectious even under extreme heat processing, such as incineration of contaminated tissues at temperatures up to 600° C. (Wiggins, 2008).

In the present invention, it was surprisingly found that natural organic polyanions, humic (HA) and fulvic (FA) substances, remove prion infectivity from living cells that were chronically infected. The authors describe that HA and FA could purge mouse scrapie-infected hypothalamic (ScGT1) cells of PrP^{Sc} (the disease-causing isoform of the prion protein) in a dose dependent manner without affecting cell viability. Furthermore, they confirmed that this inhibition occurs not only in vivo but also in vitro.

To the authors' knowledge, this is the first class of natural soil compounds shown to abate prion infection. The present invention clearly establishes the potential of HSs to promote the elimination of detectable PrP^{Sc}.

One possible mechanism is that HSs could act as a chaperon compound, the direct binding with PrP^{C} blocking the conversion reaction from PrP^{C} to PrP^{Sc}.

The present invention has important applications. In fact, the conversion of a normal PrP^{C} prion molecular structure to a pathogenic PrP^{Sc} one is irreversible as is the consequent animal diseases, for which no remedy is known. The only possible intervention is a theoretical destruction of the infected cells, i.e. of the infected tissues, organs and involved body part. This almost always means also a precautionary destruction of the entire infected animal and involved breeding. The invention allows replacement of physical destruction of infectious protein molecules by their chemical inactivation with the help of another group of natural molecules, i.e. humic acids (HAs) or fulvic acids (FAs) extractable from humus. Thus the present invention can be used for nutrition purposes as well as for agronomical and environmental applications.

Indeed, presently animal body parts such as brain and spinal marrow are destroyed as soon as made available in slaughter-houses. In addition, other organs and tissues can be utilized only after strong treatments at high temperatures and pressure. Some typical examples include meat, bone and body fluids like blood.

In both instances, as indicated in the present invention, a decontaminating treatment with HAs and FAs lead to quantitative recovery of nutrient materials without losses and expensive treatments which also result in decreased nutritive value, flavour and general acceptability of said materials for purposes of human nutrition from a general point of view. The decontaminated material can be used as animal fodder both for feeding carnivorous animals and for giving essential dietary supplements to herbivorous animals. In agronomy, potential presence of infective prions represent a problem both for use of animal wastes and for the potential diffusion of prions in crop fields and the environment in general.

Animal wastes for use in agronomy include any residue from the slaughtering process and food production. Specific treatments with HAs and FAs can solve the problem and lead to complete recovery of classical means used for enhancement of crop production, such as nitrogen and NPK organic and organo-mineral fertilizers, particularly in the case of products made from protein matrices, which are to be considered the basis for equilibrated plant nutrition;

The present invention can also be applied to amendments and soil improvers, made or added with protein matrices, which are in general the keystone or a centrepiece of soil fertility, not only from a chemical, but also from the physical, biological and mechanical point of view. At present, against the growing population, the wide loss of agricultural soil with an increase of forestry and parks, what is more surprising is that total agricultural surface in industrial countries needed to produce such higher yield of the crop, has decreased several times during the last 50 years. This implies and will imply the use of massive amounts of organic fertilizers, mainly as animal by-products. Organic matrices used for their productions should be guaranteed safe in order to avoid dissemination of prions, their transmission to animals and leaking into waters. Serious processing strategies capable to remove prions from animal tissues and organic matrices used in the production of soil fertilizers have therefore to be adopted. At the same time, in recent years the agronomic practice “agriculture without soil” has markedly arised together with massive request of amendants and organic fertilizers. If the treated agronomic environment has to be insured from potential past contamination from grazing by domestic and, possibly in future, wild animals, use of HAs and FAs is the solution to prevent contamination of soils used for crop cultivation, especially in the case of highly permeable sandy soils with a low cation exchange capacity. Contamination can also be prevented in irrigation water, particularly if it originates from potentially contaminated basins located at higher levels. A mixed soil and water reclamation could be necessary for paddy soils, where fertility depends on both water quality and infiltration behaviour in soils.

Partially similar, though sometimes even more complex problems may arise in aquaculture systems devoted to production of fish, shrimp and other aquatic organisms, where the possible presence of prions can be prevented by the use of HAs and FAs for both nutrition of aquatic animals and water discharge from aquaculture, where possible contamination can be made more difficult to afford due to the presence of organic and catabolic solid and liquid wastes released from aquatic animals.

From an environmental point of view, the main applications should be calibrated in function of the type of soil and land considered, with reference also to plants and animals and in general food chains present in each territory.

Particular consideration should be taken, in relation with possible contacts with potential sources of contamination, for the presence of settlements of mammalians; the diffusion of crops suitable for grazing; the specific type of soils; the origin and flowing characteristics of waters, also in reference to the presence of lagoons and more generally of partially stagnating waters.

Thus, humic substances (humic acid and/or fulvic acids) can be used as an aid for the removal of infectious PrP^{Sc} prions from matrices being applied to land for agricultural purposes or reaching the environment in some other way.

### SUMMARY OF INVENTION

It is therefore the object of the present invention the use of a humic substance for treating a prion contaminated area or product.

Preferably, the contaminated area is selected from the group of: soil, slaughter-house, water plants, aquaculture system.

Still preferably the contaminated product is selected from the group of: food product, meat, animal organ or tissue, organic or organo-mineral fertilizer, soil improver or amendment.

Yet preferably the humic substance is humic acid, fulvic acid or a mixture thereof.

It is another object of the present invention a composition comprising a humic substance and appropriated diluents or excipients for treating a prion contaminated area or product.

Preferably, the composition is in the form of a spray. Still preferably, the humic substance is humic acid, fulvic acid or a mixture thereof.

The invention will be now described by non limiting examples referring to the following figures:

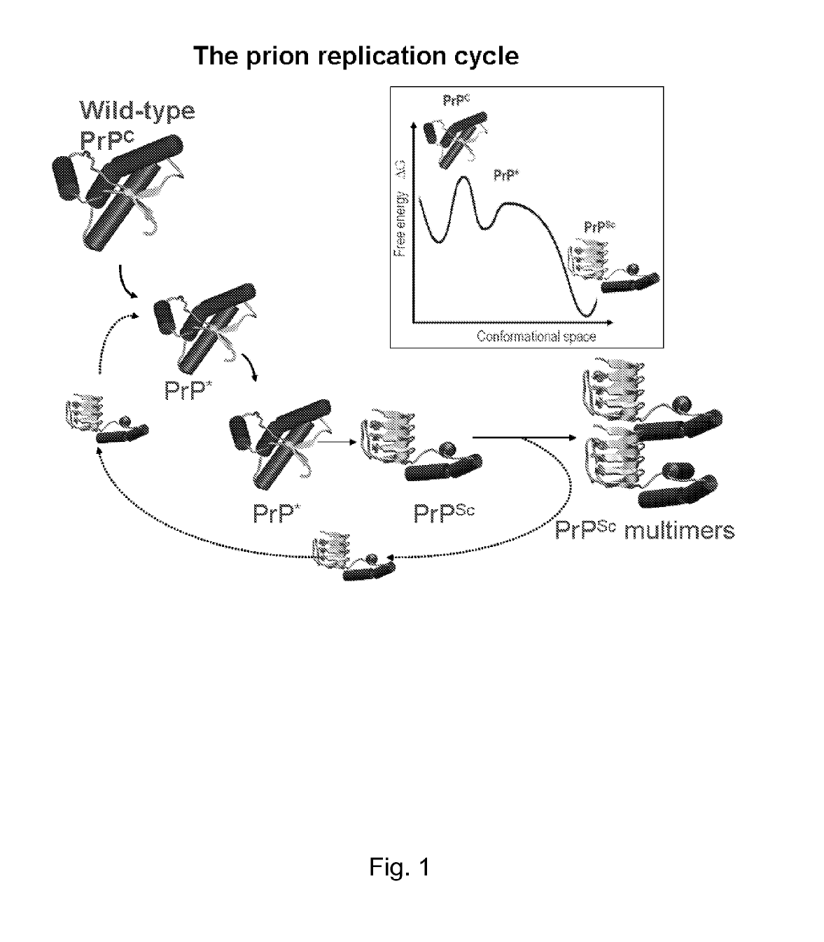

FIG. 1: The prion replication cycle model. According to the “protein-only hypothesis” by Stanley Prusiner, the conversion occurs without the need of any DNA information. During the disease, the normal form (PrP^{C}) is converted in the abnormal one (PrP^{Sc}) passing through a less stable intermediate conformer (PrP*) by a not well identified process of conversion from the α-helix motives into β-sheet secondary structures. PrP^{C} and PrP^{Sc} are characterized by the same chemical properties, but different secondary structures and physiochemical properties. PrP^{Sc}, unlike PrP^{C}, gives rise to highly ordered protein aggregate, fibrils or oligomers (PrP^{Sc} multimers). PrP^{Sc} can bind PrP^{C} which, in turn, is converted in the abnormal form too. In the upper right panel, the Gibbs free energy (or Gibbs function) is displayed energy as a function of the conformational space explaining the different Energy state from PrP^{C} to PrP^{Sc} (modified from Cohen and Prusiner, 1998).

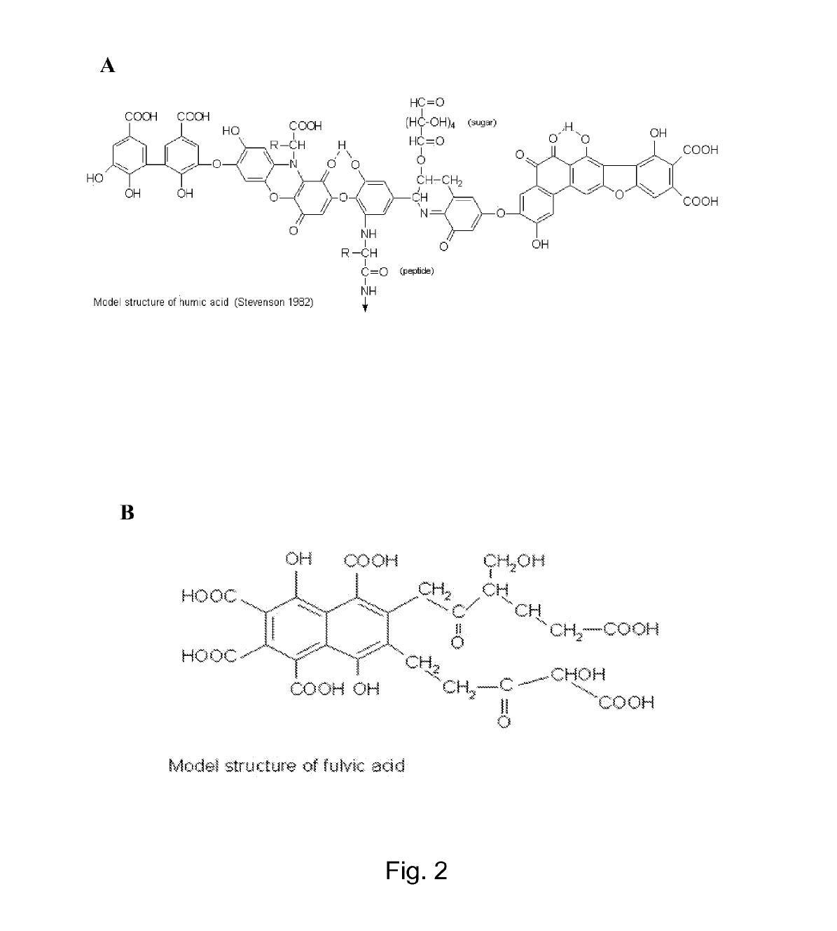

FIG. 2: Model structure of humic (A) and fulvic (B) acids.

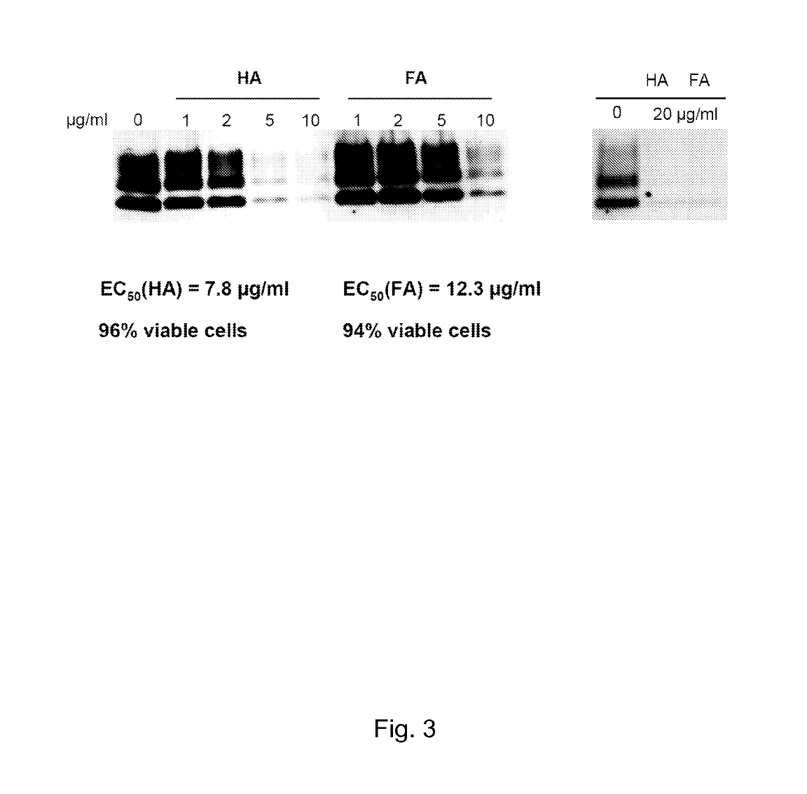

FIG. 3: Humic substances induce clearance of pre-existing PrP^{Sc}. ScGT1 cells are chronically infected by PrP^{Sc}. Western blot showing the dose dependent removal of PrP^{Sc} from ScGT1 cells. These compounds have a half maximal effective concentration (EC₅₀) of 7.8 μg/mL and 12.3 μg/mL for HA and FA, respectively. 96% and 94% of the cells remained viable after treatment with a half maximal effective concentrations of HA or FA, respectively.

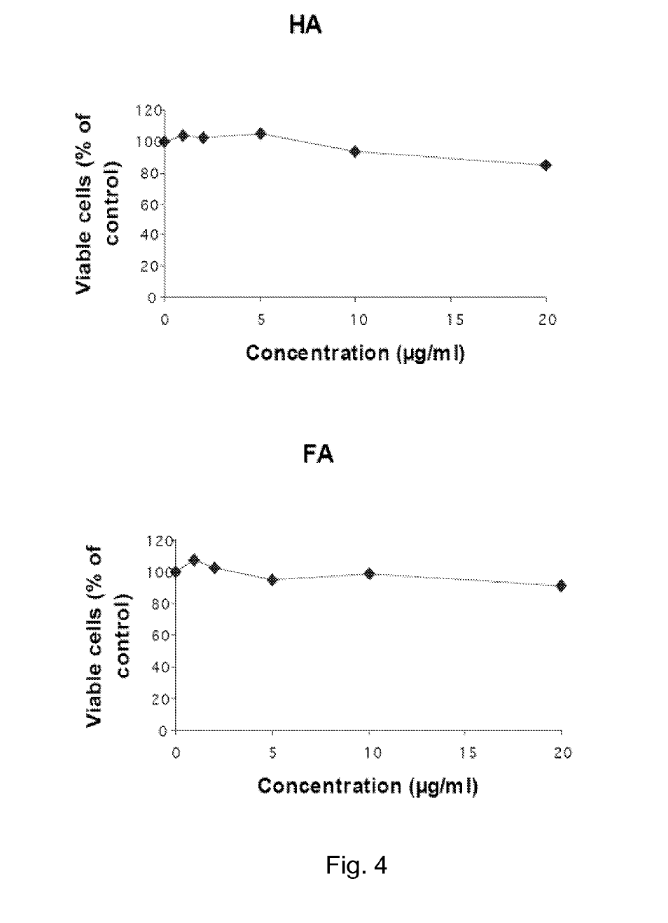

FIG. 4: Humic substances induce clearance of pre-existing PrP^{Sc}. Cell viability test to evaluate the cyto-tossicity effect of HA and FA on ScGT1 cells. Cell remain viable in the presence of different concentration of HA and FA.

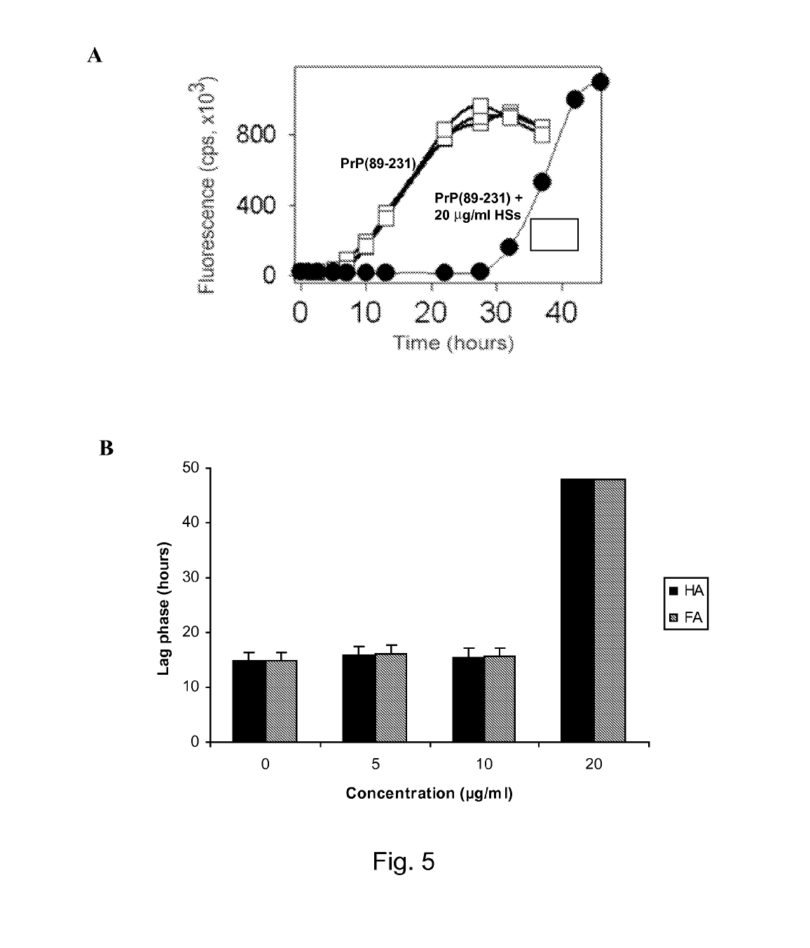

FIG. 5: Humic substances induce inhibition of fibrils formation using recPrP (MoPrP89-231). A) Thioflavin T (ThT) assay: the lag phase of MoPrP(89-231) with () and without (□) the presence of 20 μg/mL Humic Substances (HA or FA) can be observed. The graph represents typical ThT fibrillation assay performed in the presence of HA. Similar results were obtained in the presence of FA. In B) effect in lag phase duration after addition of different amount of HA (black) and FA (grey).

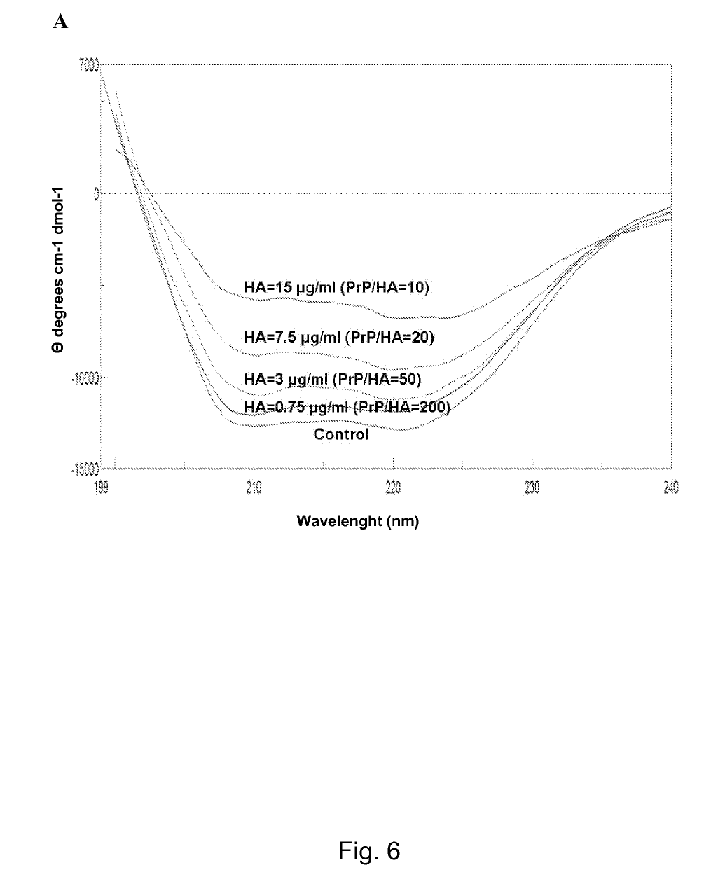

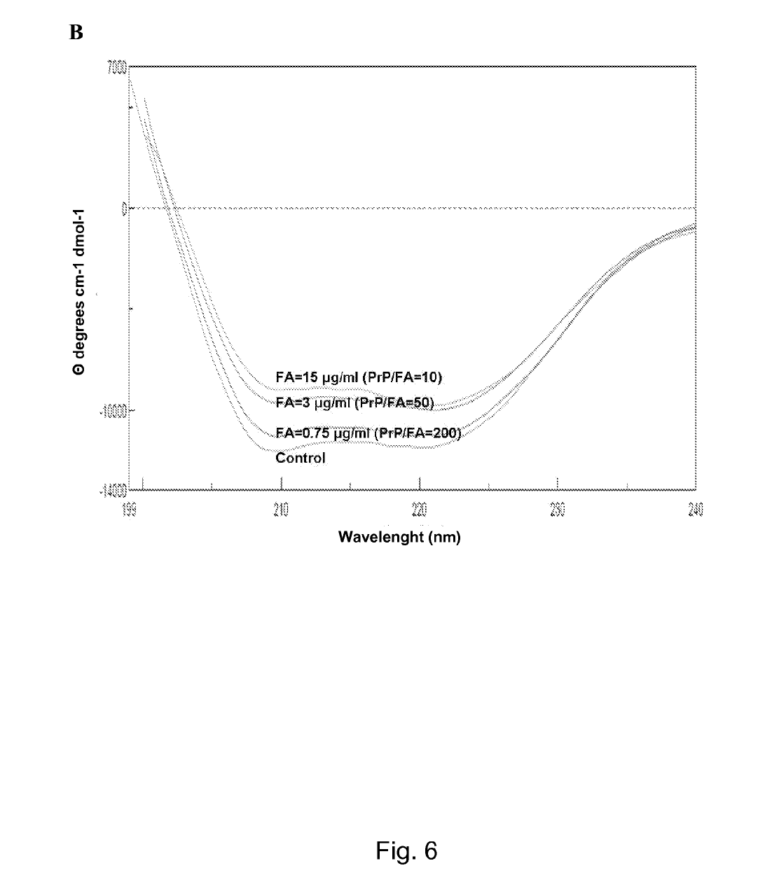

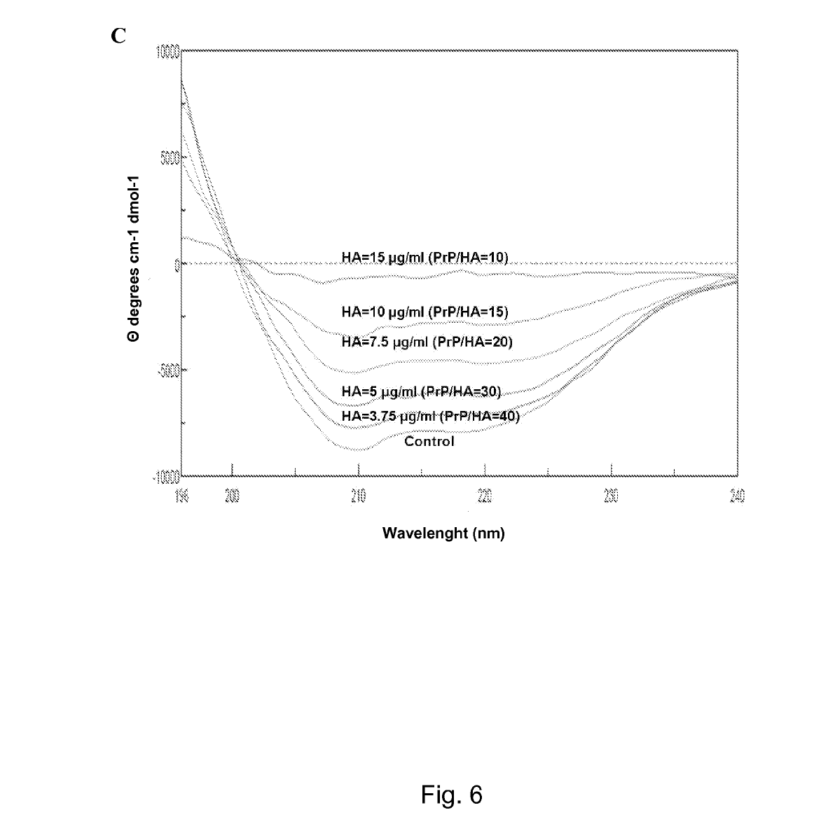

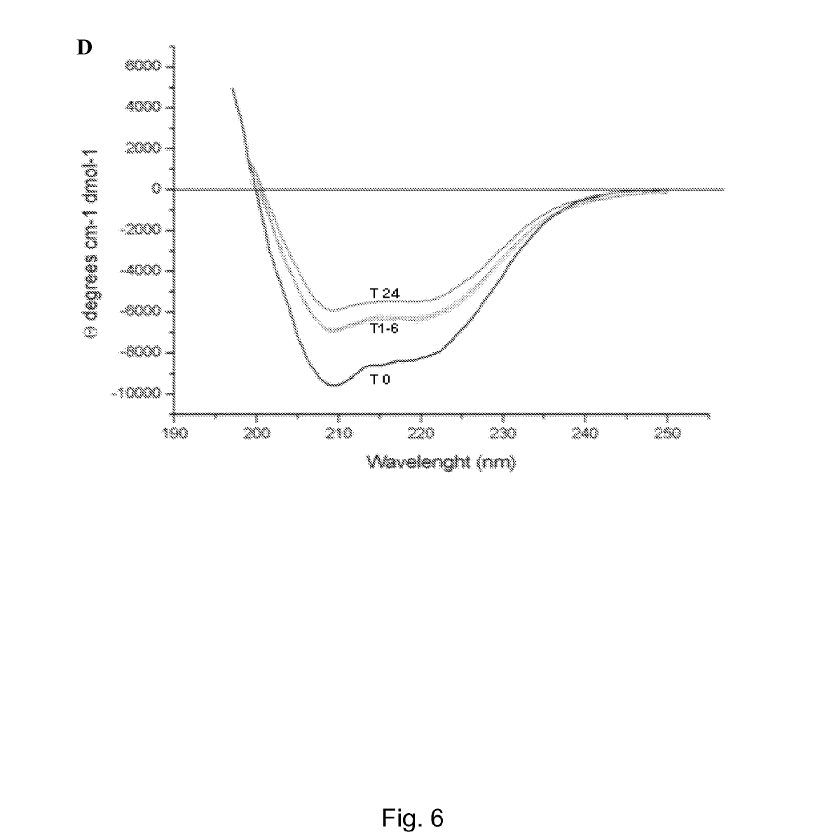

FIG. 6: The addition of 0.75, 3, 7.5, 15 μg/mL of HA (A) or FA (B) to the PrP protein (MoPrP(89-231) provokes a decrease in negative ellipticity of MoPrP(89-231). The same phenomenon is observed in MoPrP(23-231) after the addition of HA (C). D) Far UV-CD time dependent transition of MoPrP(23-231) (0.15 mg/mL) in the presence of Humic Acid (3.75 μg/mL).

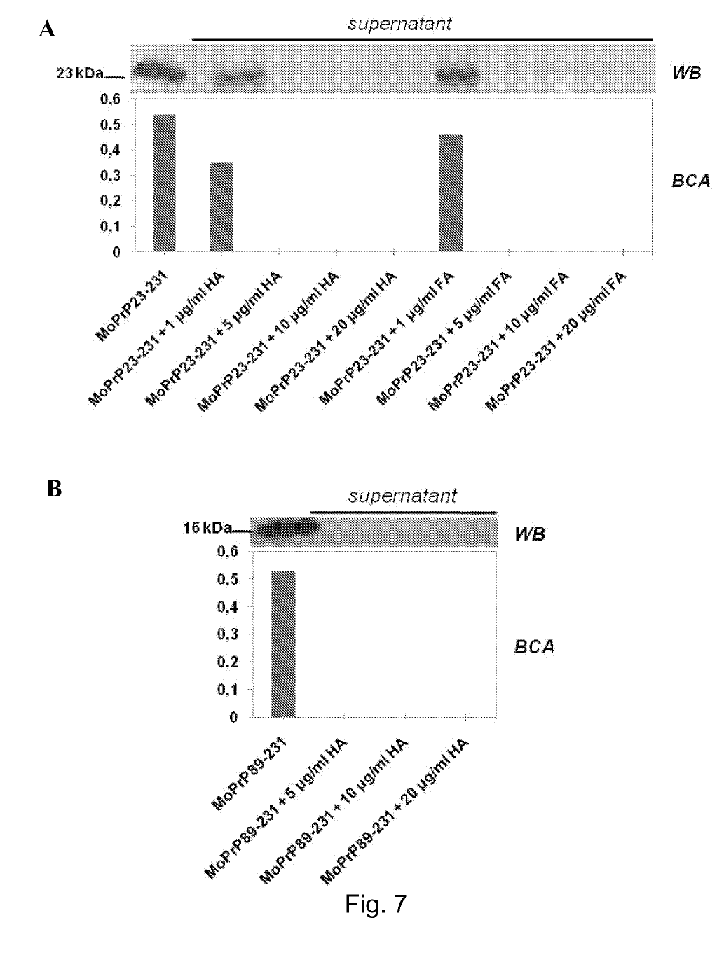

FIG. 7: Adsorption of 20 μg of MoPrP(23-231) (A) and MoPrP(89-231) (B) in the presence of 1 μg/mL to 20 μg/mL of HA and FA. No PrP protein was detected in supernatant solutions after incubation of PrP proteins with HA or FA (5-20 μg/mL), as demonstrated by Western-blotting (WB) and BCA (bicinchoninic acid) protein assay (Pierce).

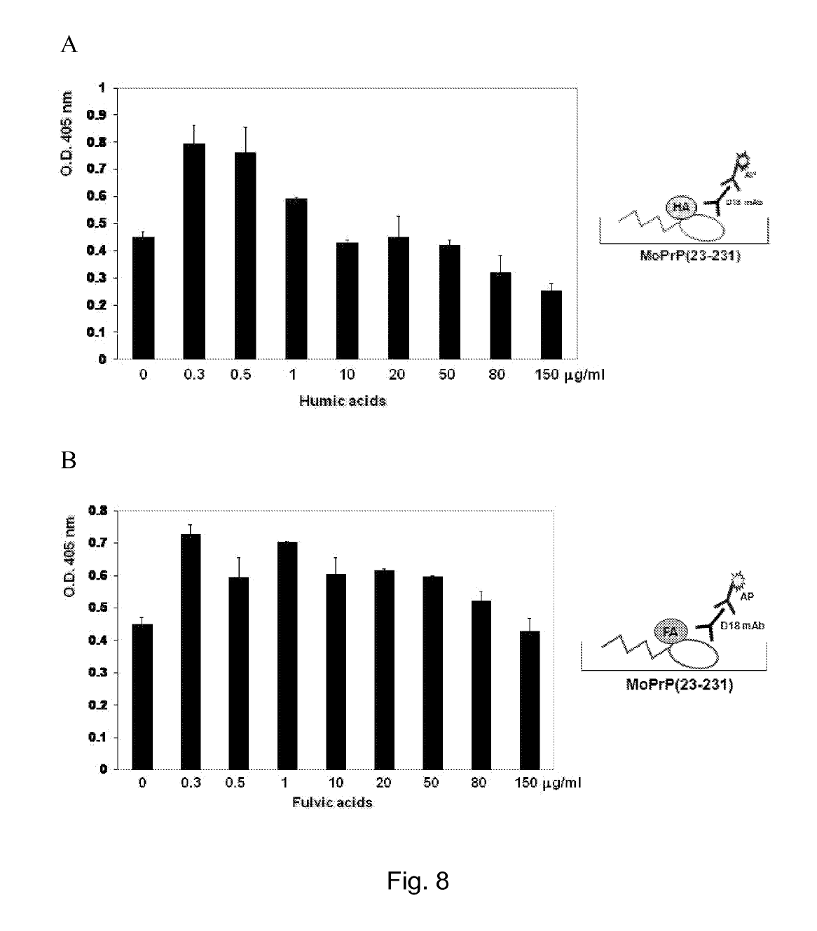

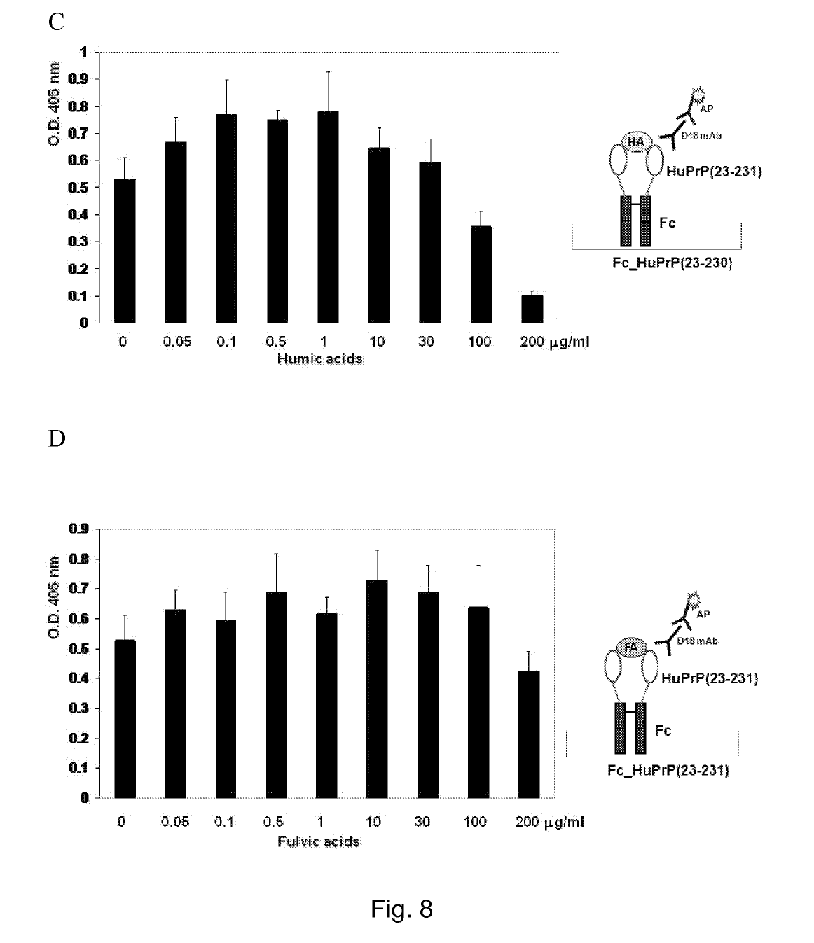

FIG. 8: Competitive ELISA assay using MoPrP(23-231) and HA (A) and FA (B). In (C) and (D) the competitive ELISA using Fc_HuPrP(23-230) and HA and FA, respectively. Coating has been performed using 1 μg for both proteins. Incubation of PrP-coated wells (either with MoPrP(23-231) or Fc_HuPrP(23-230)) with HA at concentrations HA≧100 μg/mL led to a significant decrease in absorbance due to the competitive effect between D18 antibody and HA for coated PrP proteins.

To test the binding propensity of HA and FA on another prion protein the authors used the Fc_HuPrP(23-230): this protein contains a Fc fragment linked to the N-terminal part of the PrP and it has the advantage to expose better the protein into the ELISA well.

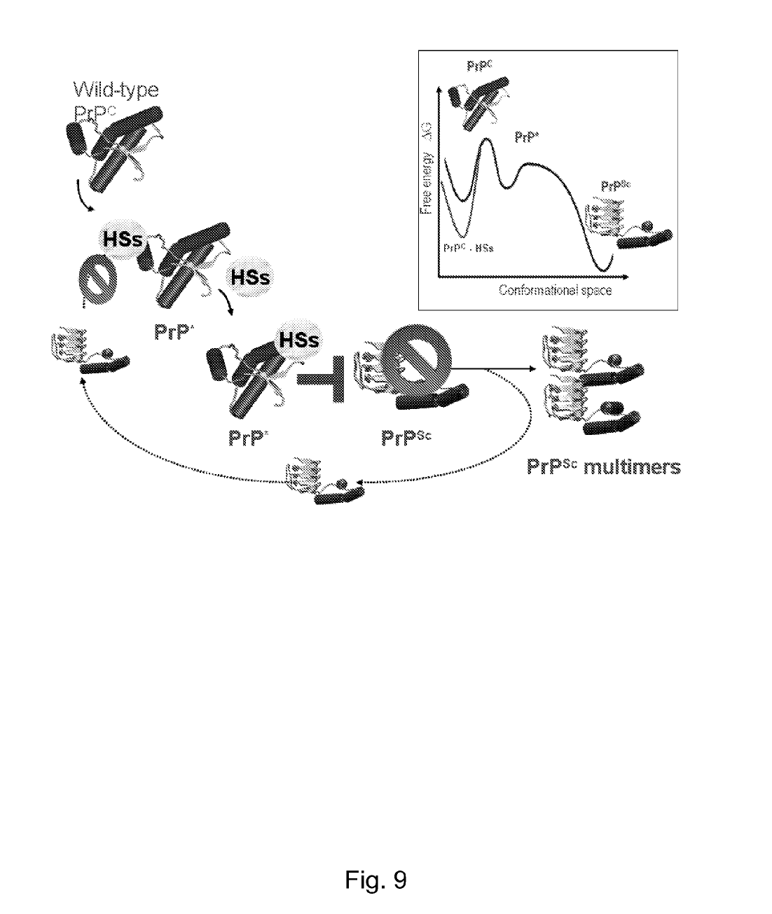

FIG. 9: Model of a possible mechanism of action of HSs during the conversion from PrP^{C} to PrP^{Sc}. The direct binding of HSs with PrP^{C} could block the conversion reaction to the pathogenic form, aging as a chaperon like compound. HSs could stabilize the PrP^{C} conformation and increase the free energy necessary for the aberrant transition (upper right panel). (Modified from Cohen and Prusiner, 1998).

### DETAILED DESCRIPTION OF THE INVENTION

### Experiment 1

To determine whether HA and FA substances can cure ScGT1 cells of scrapie infection, the authors exposed the cells to increasing concentration of HA and FA.

Materials and methods—Humic substances were extracted from agricultural soil, and purified according with the analytical procedures reported in Example 5. After exposure for 1 week to an increasing concentration of HAs or FAs (0, 1, 2, 5, 10 and 20 μg/mL), ScGT1 cells (Schatzl et al., 1997) were harvested and lysis was performed by Lysis Buffer (0.25-1 mL 20 mM Tris, pH 8.0, containing 100 mM NaCl, 0.5% Nonidet P-40, and 0.5% sodium deoxycholate) to obtain a total protein concentration of 0.1 mg/mL measured by the bicinchoninic acid assay (Pierce). Subsequently samples were incubated with 2 μg of proteinase K (Boehringer Mannheim) for 1 h at 37° C. Digested samples were then mixed with equal volumes of 2×SDS sample buffer. All samples were boiled for 10 min prior to SDS-polyacrylamide gel electrophoresis. After electrophoresis, Western blotting was performed. Blocked membranes were incubated with primary D18 monoclonal antibody (to detect mouse PrP) at 1:1000 dilution in PBST overnight at 4° C. After incubation with primary antibody, membranes were washed and incubated with horseradish peroxidase-labeled secondary antibody (Amersham Life Sciences), diluted 1:5,000 in PBST for 45 min at RT, and washed again. After chemiluminescent development with enhanced chemiluminescence (ECL) reagent (Amersham) for 1 min, blots were exposed to ECL Hypermax film (Amersham). Since PrP^{Sc} is proteinase K resistant, this is a rapid diagnostic test to evaluate the presence of prion in infected cells.

Results—After 1 week, the treatment with HA and FA compounds caused the disappearance of PrP^{Sc} from ScGT1 cells in a dose dependent manner without affecting cell viability (FIG. 3). These compounds have a half maximal effective concentration (EC₅₀) of 7.8 μg/mL and 12.3 μg/mL for HA and FA, respectively. From these data, it is clear that the most potent compounds with respect to eliminating PrP^{Sc} were Humic acids. The concentration of humic substances required to eliminate >95% of preexisting PrP^{Sc} was 20 μg/mL for both compounds. The potency of both HSs compounds in eliminating PrP^{Sc} seems dependent on their molecular weight. In fact, HA and FA have a molecular weight of 4,000 Da and 1,500 Da, respectively.

### Experiment 2

The preceding results demonstrate the potent ability of HSs compounds to clear PrP^{Sc} from ScGT1 cells. To explore whether these compounds could be used as a potential therapeutic for treatment of prion disease, the authors tested whether they were cytotoxic for ScGT1 cells, using as criteria cell growth, morphology, and viability as measured by trypan blue staining None of the compounds was cytotoxic to ScGT1 cells after exposure for 1 week at concentrations up to 20 μg/mL (FIG. 4).

### Experiment 3

Encouraged by their success in reversing the accumulation of PrP^{Sc} in ScGT1 cells under non-cytotoxic conditions, the authors tested the anti-prion activity of HSs substances using an in vitro amyloid conversion assay for prions. This test represents a useful tool to simulate the aggregation kinetics of the prion protein. The presence of drug-compounds binding PrP^{C} could have an effect on the kinetic of fibrils formation. The lag phase corresponds to the time prior the fibrils formation. Stronger is the effect of a drug longer is the lag phase.

In this experiment, the authors observed that HSs compounds strongly inhibit the aggregation propensity of MoPrP(89-231). In particular, they observed that the lag phase of MoPrP(89-231) is longer in the presence of 20 μg/mL of either HA or FA.

Materials and Methods—To monitor the fibril formation the authors performed the Thioflavin T (ThT) assay. ThT fluorescence has been monitored at an emission wavelength of 485 nm and an excitation wavelength of 450 nm. During the time course of amyloid formation, a solution of ThT, 20-fold more concentrated than the final protein concentration, in phosphate buffered saline has been added to aliquots of 10 μg recombinant PrP at room temperature, 25° C. and 37° C. In situ, fluorescence will be monitored in a 96-well fluorescence plate reader (450 nm excitation and 485 nm emission). ThT fluorescence intensity has been read automatically every minute with shaking between measurements. For the screening of HSs compounds different concentration of HA and FA (5-10-20 μg/mL) has been added to the MoPrP solutions (50 μg/mL). For this experiment the authors used two types of recombinant Mouse Prion Protein (Accession number: NP_{—}035300): one including residues from 89 to 231 (MoPrP(89-231)) and the other including residues from 23-231 (MoPrP(23-231)). The first one is the canonical PrP fragment found in amyloid plaque during prion disease, whereas the second one is the mature physiological prion protein.

Results—Anti prion propensity of HSs has been evaluated considering the time required to the recPrP solutions to form fibrils. The time prior to the fibrilization is called lag phase. In FIG. 5A) we can observe the Thioflavin T (ThT) assay with the lag phase of MoPrP(89-231) with () and without (□) the presence of 20 μg/mL Humic Substances (HA or FA). In the presence of a concentration of HSs≧20 μg/mL the authors observed a significant longer lag phase in comparison with the control (FIG. 5B).

This test supports the authors' findings that HA and FA act as anti-prion agent both in vivo and in vitro.

### Experiment 4

To start to elucidate the mechanism of action of HSs on the PrP, the authors investigate the effect of HA and FA on the secondary structure of recMoPrP(89-231) and recMoPrP(23-231) using: (i) Far-UV Circular Dichroism (CD), (ii) adsorption assay using Western blot and BCA (Pierce) analysis of the supernatant solutions after ultracentrifugation, (iii) ELISA.

In the absence of HA or FA, the spectra MoPrP(89-231) and MoPrP(23-231) have a double minimum at 222 and 208 nm, characteristic of α-helical structure, typical of PrP^{C}. Interestingly, the addition of HA or FA to the protein provokes a decrease in negative ellipticity (FIG. 6). In particular, the effect is stronger in presence of HA both for MoPrP(89-231) (FIG. 6A) and MoPrP(23-231) (FIG. 6C). Moreover, time-dependent transition of MoPrP(23-231) in the presence of HA was observed (FIG. 6D). Changes in molar ellipticity could be related to two hypotheses: (a) they are due to conformational changes of the secondary structure (i.e. loss of α-helical content) or (b) partial protein precipitation. To demonstrate that changes in molar ellipticity are due to the precipitation of the PrP in the presence of HSs, the authors measured adsorption of 20 μg of MoPrP(89-231) and MoPrP(23-231) in the presence of 1 μg/mL to 20 μg/mL of HA and FA. No prion protein was detected by Western blot and BCA (Pierce) analysis of the supernatant solutions after ultracentrifugation (100,000 g) at HSs concentration up to 5 μg/mL (FIG. 7). Finally, the authors measured the propensity of HSs on the binding with MoPrP(23-231) using the method of competitive ELISA. The authors' results suggest that HA bind PrP specifically (FIG. 8).

### Experiment 5

Extraction and characterization of humic substances.

Materials and Methods—Extraction and purification of HS was carried on the basis of the procedures published by International Humic Substances Society (IHSS) and Sequi et al. (Sequi et al., 1986), both previously reported (R. S. Swift, 1996) with the following amelioration in order to optimize the analytical efficiency. Briefly, HS were extracted from 2 mm-sieved soil sample with 0.1 M NaOH (1:5 wt/vol). The suspension was left overnight under a N₂ atmosphere with constant shaking. After a slower centrifugation at 13,000 rpm to remove the bulky material, the extract was centrifuged at 24,000 rpm and filtrated through a 0.45 μm nitrocellulose filter. The filtrate was then acidified until pH 2 with H₂SO₄ to precipitate humic acids. After centrifugation the supernatant was collected, and the pellet (humic acids, HA) resuspended with 0.5 NaOH and stored. The supernatant was fed on a column packed with polyvinylpyrrolidone (PVP), previously equilibrated in 0.01 M H₂SO₄. The eluate (the non-retained, non-humified fraction) was discarded, while the brown-coloured retained fraction (fulvic acids, FA), was subsequently eluted with 0.5 M NaOH. Both fractions were passed through H+ exchanging resin to remove metal ions and adjusted to pH 7. The organic carbon content of the HA and FA fraction were measured by wet oxidation method (It. Min. Lex n.248 Oct. 21^{st} 1999).

In conclusion, the present invention surprisingly demonstrate that non-cytotoxic concentrations of naturally occurring humic (HA) and fulvic (FA) substances can rapidly eliminate PrP^{Sc} from chronically infected ScGT1 cells.

Furthermore, the amyloid seeding assay (ASA) of MoPrP(89-231) and MoPrP(23-231) showed a considerably longer lag phase in the presence of increasing concentration of HAs and FAs.

Moreover, the interaction between recMoPrPC and HA, FA using Far UV Circular Dicroism and ELISA assays is showed.

### REFERENCES

Ar\check{c}n I., et al., 2006 Environmental Chemistry Letters 4, 191-194.
Borges, F., et al., 2005. Talanta 66, 670-673.
Campitelli, P. A., Velasco, M. I., Ceppi, S. B., 2006. Talanta 69, 1234-1239.
Chien, Y. Y., Bleam, W. F., 1997. Langmuir 13, 5283-5288.
Cozzolino, A et al., 2001. Soil Biology and Biochemistry 33(4-5), 563-571.
De Paolis, F., Kukkonen, J., 1997. Chemosphere 34, 1693-1704.
Fang, F. et al. 1998. Analytica Chimica Acta 373(2-3), 139-151.
Fetsch, D., Havel, J., 1998. Journal of Chromatography A 802(1), 189-202.
Genovesi S., et al. 2007. PLoS One-10, 1-6 code 1069Gevao, B., Semple, K. T., Jones,
K. C. 2000. Environmental Pollution 108, 3-14.
Guetzloff, T. F., Rice, J. A., 1994. The Science of the Total Environment, 152, 31-35.
Ishiwata, S., Kamiya, M., 1999. Chemosphere 39, 1595-1600.
Klaus, U., et al. 2000. Environmental Science and Technology 34, 3514-3520.
Klöcking, R. et al., 1972. Experientia, 28(5), 607-608.
Klöcking, H-P., 1991. Vol. 33, Earth Sciences, Springer-Verlag, Berlin, pp. 423-428.
Kurk, D. N., Choppin, G. R, 2000. Radiochimica Acta 88(9-11), 583-586.
Lee, R. T., Shaw, G., Wadey, P., Wang, X., 2001. Chemosphere 43(8), 1063-1070.
Leita, L. et al, 2001. Soil & Sediment Contamination: an International Journal, 10, 483-496.
Leita L. et al. 2006. Soil Biology and Biochemistry. Vol 38: 1638-1644.
Leita, L. et al. 2009. Environmental Pollution 157(6), 1862-1866.
Loya, S. et al. 1993. Journal of Natural Products 52(12), 2120-2125.
Lubal, P., \check{S}iroký, D., Fetsch D., Havel J., 1998. Talanta 47, 401-412.
Lubal, P. et al., 2000. Talanta 51(5), 977-991.
Myneni, S. C. B., 2002. Science 295, 1039-1041.
Nam, K., Kim, J. Y., 2002. Environmental Pollution 118, 427-433.
Pacheco, M L et al. 2001. Journal of Radioanalytical and Nuclear Chemistry 248, 565-570.
Pacheco, M. L., Peña-Méndez, E. M., Havel J., 2003. Chemosphere 51(2), 95-108.
Peña-Méndez, E. N., Havel, J., Pato\check{c}ka, J., 2005. Journal of Applied Biomedicine 3, 13-24.
Perminova, V. et al. 2003. Environ. Sci. & Technol, 37, 2477-2485
Piccolo, A., 2002. Advances in Agronomy 75, 57-134.
Riede, U. N. et al, 1991. Virchows Arch B Cell Pathol Incl Mol Pathol 60(1), 27-34.
Schatzl, H. M., L. Laszlo, et al. (1997). J Virol 71(11): 8821-31.
Schiller, F. et al., 1979. Dermatoi Monatsschr 165(7), 505-509.
Schmitt, Ph. et al., 1997. Chemosphere 35, 55-75.
Schneider, J. et al, 1996. Virology 218(2), 389-395.
Schulten, H.-R., Thomsen, M., Carlsen, L., 2001. Chemosphere 45, 357-369.
Schols, D. et al., 1991. Journal of Acquired Immune Deficiency Syndromes 4(7), 677-685.
Sequi, P., De Nobili, M., Leita, L., Cercignani, G., 1986. Agrochimica 30, 1-2, 175-179
Shermer, C. L. et al., 1998. Journal of the science of food and agriculture 77(4), 479-486.
Steed, J. W., Atwood, J. L., 2000. Supramolecular Chemistry. John Wiley & Sons, London.
Stevenson F. J., 1994. Humus Chemistry: Genesis, Composition, Reactions. John Wiley & Sons, New York.
Swift, R. S. 1996. Organic matter characterization. SSSA Book Series:5 Methods of Soil
Analysis, part 3-chemical methods. SSSA Publ. Madison Wis., 1011-1069
Von Wandruszka R, 1998. Soil Sci 163, 12, 921-930
Von Wandruszka, R et al., 1999. Organic Geochemistry, 30, 229-235

1-4. (canceled)

5. A composition comprising a humic substance and appropriated diluents or excipients for treating a prion contaminated area or product.

6. The composition according to claim 5 in the form of a spray.

7. The composition according to claim 5 wherein the humic substance is humic acid, fulvic acid or a mixture thereof.

8. A method for treating a prion contaminated area or product, comprising contacting a prion contaminated area or product with a humic substance.

9. The method of claim 8, wherein the contaminated area is selected from the group consisting of: soil, slaughter-house, water plants, and aquaculture system.

10. The method of claim 8, wherein the contaminated product is selected from the group consisting of: food product, meat, animal organ or tissue, organic or organo-mineral fertilizer, soil improver and amendment.

11. The method of claim 8, wherein the humic substance is humic acid, fulvic acid or a mixture thereof.
